(19) United States
(12) Patent Application Publication
(10) Pub. No.: US 2025/0017145 A1
(43) Pub. Date: Jan. 16, 2025

(54) HAYMAKING MACHINE

(71) Applicant: MASCHINENFABRIK BERNARD KRONE GMBH & CO. KG, SPELLE (DE)

(72) Inventors: BERND JOHANNING, MELLE (DE); ANDREJ BAISER, OSNABRUECK (DE)

(73) Assignee: MASCHINENFABRIK BERNARD KRONE GMBH & CO. KG, SPELLE (DE)

(21) Appl. No.: 18/766,675

(22) Filed: Jul. 9, 2024

(30) Foreign Application Priority Data
Jul. 14, 2023 (DE) 10 2023 118 726.0

(51) Int. Cl. A01D 78/00; A01D 78/10; A01D 80/00

(52) U.S. Cl. CPC A01D 78/007; A01D 78/1057; A01D 78/1078; A01D 80/00

(57) ABSTRACT

A haymaking machine includes a frame, a turning or raking rotor and a sensor arranged on the frame, and a control device. In a working position, the turning or raking rotor is drivable relative to the frame about an axis of rotation in a direction of rotation. The turning or raking rotor has tine arms which have tines. The tine arms are aligned at least temporarily to face the ground. The tine arms are arranged uniformly distributed in a circumferential direction around the axis of rotation and are aligned in an approximately radial direction with respect to the axis of rotation. The sensor continuously detects a passing of the tine arms during an operation of the turning or raking rotor and transmits a measurement signal thereof. The control device receives the measurement signal and infers an operating state of the at least one turning or raking rotor based thereon.

### CROSS REFERENCE TO PRIOR APPLICATIONS

Priority is claimed to German Patent Application No. DE 10 2023 118 726.0, filed Jul. 14, 2023. The entire disclosure of said application is incorporated by reference herein.

### FIELD

The present invention relates to a haymaking machine, in particular to a rotary tedder or rotary rake, with a frame on which at least one turning or raking rotor is arranged, which in a working position can be driven relative to the frame about a rotary axis in a rotary direction, and which has at least two or more tine arms with tines for turning or raking the crop, which are aligned at least temporarily facing the ground, wherein the tine arms are arranged uniformly distributed in a circumferential direction around the gyratory axis of rotation and are aligned in an approximately radial direction with respect to the gyratory axis of rotation. The present invention further relates to a work train/coupled unit comprising a tractor and such a haymaking machine.

### BACKGROUND

Such haymaking machines are known from the state of the art in various embodiments and are used to spread and turn agricultural stalks and leaves lying on a field or meadow surface to support the drying process, or to combine them into windrows so that the crop can then be picked up and further processed. The tines arranged on the tine arms of the turning or raking rotors, which are driven in rotation during operation, engage with the crop during the rotational movement.

Optimum adjustment of the hay harvesting machine is crucial for the quality of the work result, i.e., the quality of the forage produced. To achieve this, the operator traditionally monitors a large number of machine parameters continuously during the harvesting process, such as the speed of the raking rotors, their working height setting, and/or the driving speed of the hay harvesting machine. The operator also carries out regular visual inspections to assess the machine's behavior and the work result and to manually readjust the haymaking machine if necessary. This is time-consuming and strenuous for the operator.

### SUMMARY

An aspect of the present invention is to improve a haymaking machine so that the monitoring effort for the operator during the harvesting process is reduced, damage to the haymaking machine is detected at an early stage so that damage is consequently avoided, and the work result is optimized.

In an embodiment, the present invention provides a haymaking machine which includes a frame, at least one turning or raking rotor which is arranged on the frame, a sensor, and a control device. The at least one turning or raking rotor is configured so that, in a working position, it is drivable relative to the frame about an axis of rotation in a direction of rotation of the at least one turning or raking rotor. The at least one turning or raking rotor comprises at least two tine arms each of which comprise tines for turning or raking a crop. The at least two tine arms are aligned at least temporarily so as to face the ground. The at least two tine arms are arranged uniformly distributed in a circumferential direction around the axis of rotation of the at least one turning or raking rotor and are aligned in an approximately radial direction with respect to the axis of rotation of the at least one turning or raking rotor. The sensor is arranged on the frame. The sensor is configured to continuously detect a passing of the at least two tine arms during an operation of the at least one turning or raking rotor and to transmit a measurement signal thereof. The control device is configured to receive the measurement signal transmitted by the sensor and, based thereon, to infer an operating state of the at least one turning or raking rotor.

### BRIEF DESCRIPTION OF THE DRAWINGS

The present invention is described in greater detail below on the basis of embodiments and of the drawings in which:

FIG. 1 shows a work train comprising a tractor and a haymaking machine attached to the tractor;

FIG. 2 shows (a) a part of a further embodiment of a haymaking machine, and (b) an enlarged section of FIG. 2 (a); and

FIG. 3 shows in each of (a) to (c) measurement signals from a sensor of the haymaking machines in FIGS. 1 and 2.

### DETAILED DESCRIPTION

The haymaking machine has a frame on which at least one turning or raking rotor is arranged. In a working position, the turning or raking rotor can be driven relative to the frame about an axis of rotation of the rotor in a direction of rotation of the rotor. The turning or raking rotor has at least two or more tine arms, each of which has tines are arranged thereon.

Such a haymaking machine can be designed as a rotary tedder or a rotary rake. In the rotary tedder, the tines are intended for turning, i.e., spreading, the crop. The tines of the rotary rake are in contrast designed to windrow, i.e., to gather the crop. The tines are at least temporarily aligned towards the ground for this purpose. This allows the tines to engage with the crop and lift the crop from the ground or from the crop hub. During the rotational movement, the crop then detaches from the tines and is ejected in a desired direction.

For this purpose, the tine arms are evenly distributed in a circumferential direction around the axis of rotation of the rotary axis and aligned in an approximately radial direction to the axis of rotation of the rotary axis. The tine arms can be straight, curved, and/or angular. On level ground, the turning or raking rotor rotates around an approximately vertically aligned axis of rotation. In contrast to the rotary tedder, in which the alignment of the tines to the ground does not change during a full rotation of the turning or raking rotor, the tine arms of the rotary rake are rotated during the rotation so that the tines of the rotary rake are only aligned towards the ground for lifting the crop.

The haymaking machine also has a sensor. The sensor is arranged on the frame. It is therefore stationary relative to the tine arms of the turning or raking rotor when the haymaking machine is in operation, i.e., when the turning or raking rotor is driven. The sensor is set up to continuously detect when the tine arms pass the sensor during operation of the turning or raking rotor.

The haymaking machine also has a control unit. The control unit interacts with the sensor in order to draw conclusions about the operating status of the turning or raking rotor based on a measurement signal from the sensor transmitted to the control unit.

Collisions with obstacles can cause the tine arms of hay harvesting machines to bend or even break off an entire tine arm or cause further damage to the drive train of the turning or raking rotor. As this means that the crop is no longer processed evenly or completely, bending or missing tine arms leads to a deterioration in the quality of the work result. A bent or missing tine arm also causes an imbalance, which can result in further consequential damage, particularly in the drive train and/or a rotor gearbox of the turning or raking rotor.

It has traditionally been up to the operator of the haymaking machine to detect such damage by observing the machine's behavior and the work result. Via detection using the sensor, the operator can react very quickly and the negative effects in terms of the work result and/or consequential damage can be avoided.

For each full rotation of the turning or raking rotor, the sensor detects each tine arm of the turning or raking rotor exactly once. The sensor's measurement signal for the passing of (each) tine arm at the sensor (in each case) can, for example, have a signal deflection (peak). The tine arms of the turning or raking rotor can, for example, be essentially identical in design. The measuring signal of the sensor thereby has a constant distance between the signal deflections in normal operating mode at a constant rotor speed.

The haymaking machine can, for example, comprise a gyro gear for converting, i.e., reducing or overdrive, a PTO speed into a gyro speed. The control device can, for example, be set up to calculate a target gyro speed of the turning or raking gyro, taking into account the PTO shaft speed for driving the gyro gear, and/or a conversion ratio of the gyro gear. The gyro gear can, for example, be driven by a PTO shaft.

The PTO speed is the speed of a power supply for the turning or raking rotors. For the power supply, the haymaking machine is conventionally connected with the PTO shaft to a power take-off (PTO) auxiliary drive of a tractor pulling or carrying it. The PTO speed can be measured in a known manner.

The control device is set up to calculate the target rotor speed of the turning or raking rotor from the quotient of the PTO shaft speed and the conversion ratio. It is also set up to continuously determine a current actual rotor speed based on the number of tine arms of the turning or raking rotor and a frequency of the signal deflections of the measurement signal per full rotation of the turning or raking rotor.

In an embodiment of the present invention, the control device is also set up to compare the setpoint rotor speed with the actual rotor speed, and to detect an operating state as a fault operation if a deviation between the setpoint rotor speed and the actual rotor speed is more than 10%, for example, more than 15%.

During operation of the haymaking machine, the target rotor speed and the actual rotor speed are approximately the same in a normal operating mode. By comparing the target rotor speed with the actual rotor speed, it is therefore possible to conclude that there is a malfunction, for example, slippage, a turning, a raking rotor hitting an obstacle, or a defect in the drive train.

In an embodiment of the present invention, the control device can, for example, be set up to determine a target distance of the signal deflections, to compare the target distance with a current actual distance of neighboring signal deflections of the measurement signal, and to detect an operating state as a fault operation if the actual distance deviates from the target distance by a value that corresponds to an angular error of more than 8° of a rotor rotation, in particular more than 10°, and/or if the actual distance deviates from the target distance over more than one full rotation of the turning or raking rotor.

The target distance can be calculated from the target rotor speed. If the distance is increased or reduced, it is possible, for example, to conclude that a “bent tine arm” fault mode has occurred because the tine arm enters a detection range of the sensor earlier or later or not at all. With an increased distance, for example, a fault mode “missing tine arm” can also be concluded because the tine arm does not enter a detection range of the sensor at all.

The control device can, for example, be set up to detect an impact of the turning or raking rotor on an obstacle, a bent tine arm, a missing tine arm, a slip in a drive train of the turning or raking rotor, and/or a defect in the drive train by comparing the set distance and the actual distance as an operating state of fault operation.

The sensor can, for example, be designed as a reed sensor, an inductive sensor, a capacitive sensor, an ultrasonic sensor, or a light sensor, in particular a light sensor or light barrier. The design as an inductive sensor does not, for example, result in the measurement being distorted or hindered by dust and crops.

The present invention also provides a work train/coupled unit comprising a tractor and such a haymaking machine, wherein the haymaking machine is attached to the tractor, in particular via a drawbar, or is mounted on the tractor, in particular on a three-point hitch of the tractor.

The tractor can, for example, comprise a tractor control unit, whereby the control unit is set up to transmit the fault operation to the tractor control unit. The tractor control system can also be set up to transmit control signals to the tractor to control the haymaking machine in response to the malfunction. The control device of the haymaking machine and the tractor control system of the tractor can, for example, be connected to each other in a signal-transmitting manner for this purpose, for example, via standardized protocols such as ISOBUS or TIM or a proprietary protocol.

In an embodiment of the present invention, the tractor control system can, for example, be set up to display the malfunction operating status to the operator. This allows the operator to react to the respective faulty operation at an early stage and to eliminate the fault or to initiate measures to remedy the situation and/or avoid consequential damage. The control device can also, for example, be set up to initiate an auxiliary measure to prevent consequential damage and/or to transfer the haymaking machine to a fault position.

Such an auxiliary measure to prevent consequential damage can, for example, be reducing the rotor speed or stopping the operation of the turning or raking rotor or the haymaking machine. Another measure can be to move the haymaking machine into a headland or transport position.

The control device of the haymaking machine can alternatively cause the tractor control system to initiate an auxiliary measure to prevent consequential damage and/or to transfer the haymaking machine to a fault position. This type of automation makes it possible to react very quickly to a malfunction. It can also be used with an autonomous work train comprising an autonomous tractor.

The present invention makes it possible to use relatively few, inexpensive sensors to detect different fault conditions of the haymaking machine at an early stage and independently of the operator's subjective impressions. This can reduce consequential damage. Inadequate work results are prevented. The operator is also relieved by the sensory detection.

The present invention is described in greater detail below with reference to the drawings. The drawings are thereby merely exemplary and do not limit the general idea of the present invention.

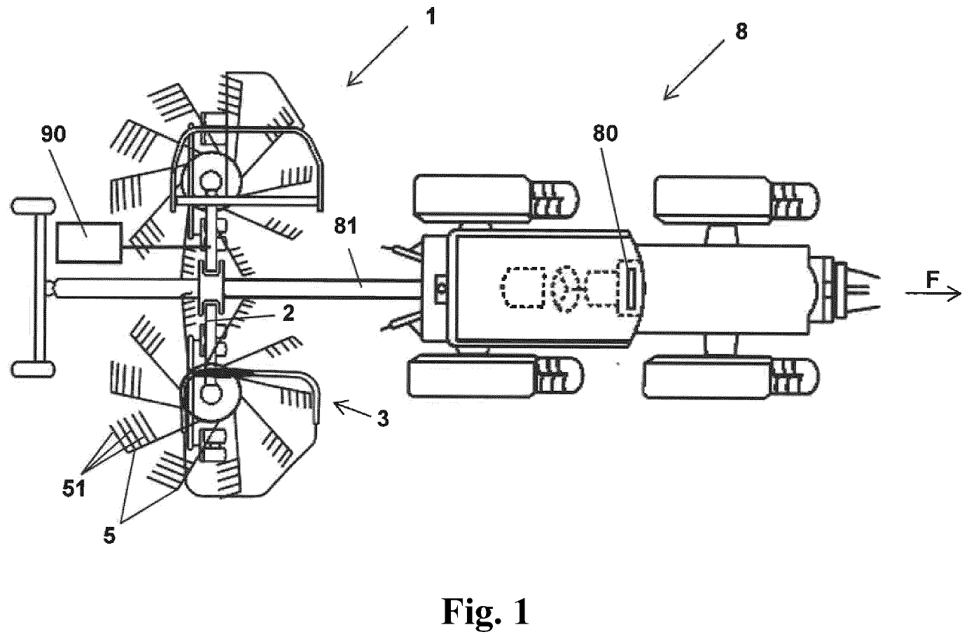

FIG. 1 shows a work train comprising a tractor 8 and a haymaking machine 1, which is attached to the tractor 8 via a drawbar 81. The haymaking machine is here a rotary rake 1 so that the terms haymaking machine 1 and rotary rake 1 are used synonymously with respect to FIG. 1.

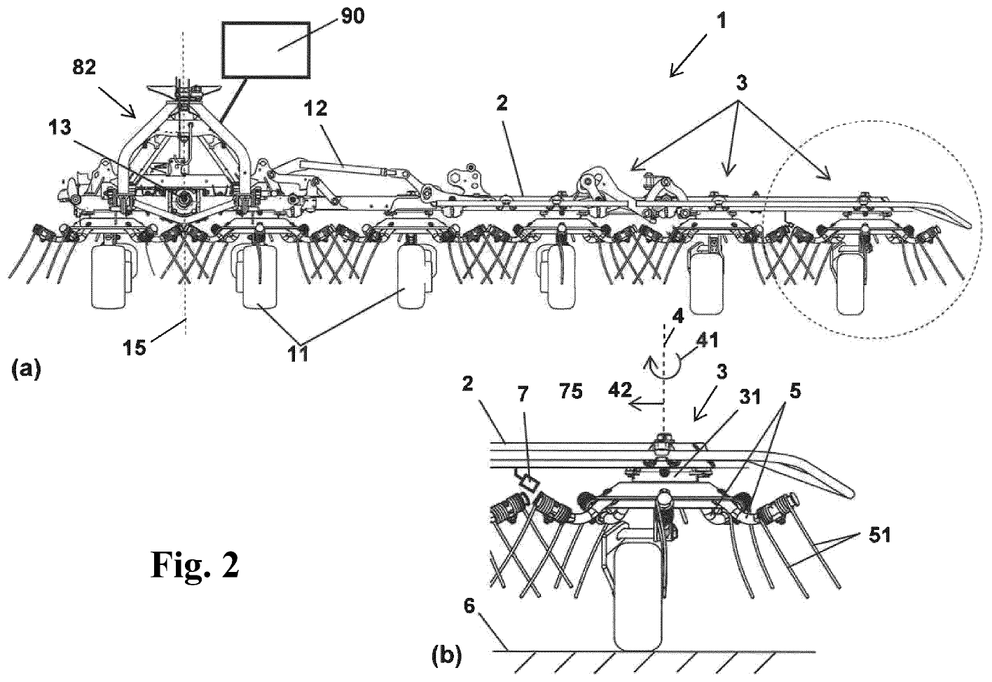

The rotary rake 1 has, for example, two turning or raking rotors 3 which are arranged next to each other at right angles to the direction of travel F of the working train. The rotary rake 1 has a frame 2, which is here designed as a machine beam 2 that extends transversely to the direction of travel F. The turning or raking rotors 3 are arranged at opposite ends (not indicated) of the machine beam 2. They are designed to pick up crops from the ground 6 (see FIG. 2) or a sward and deposit them in a swath (not shown) between the turning or raking rotors 3. The turning or raking rotors 3 therefore here have the function of raking rotors.

The turning or raking rotors 3 can for this purpose be rotated in opposite directions 41 around a rotation axis 4 (see FIG. 2) which is aligned vertically on level ground. To pick up the crop, the turning or raking rotors 3 have a plurality of tine arms 5 on which tines 51 are arranged (see FIG. 2). During operation of the rotary rake 1, the tine arms 5 are rotated about an axis (not shown) which is aligned approximately radially to the rotation axis 4 so that the tines 51 of the rotary rake 1 only face the ground 6 when penetrating the crop. The rotation prevents them from engaging in the deposited swath and destroying it.

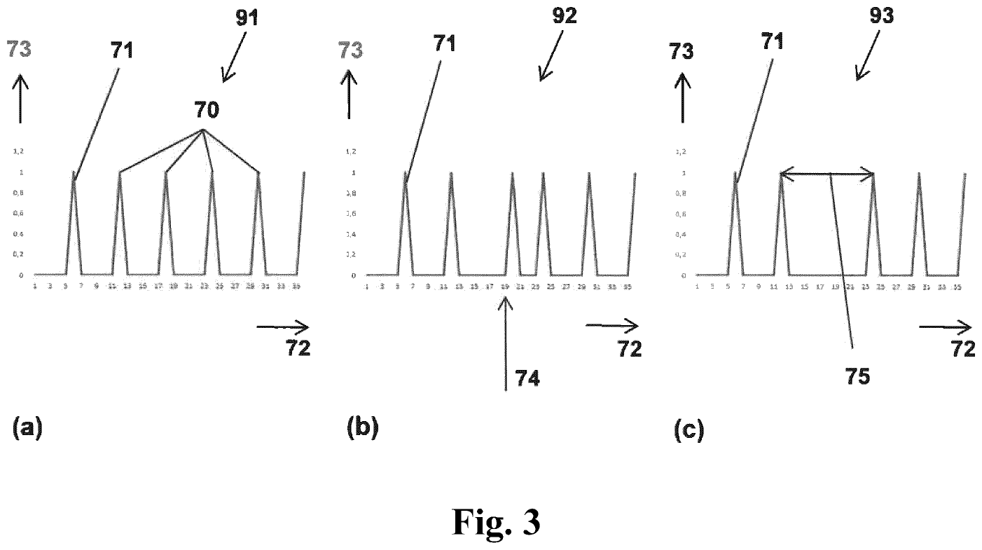

Collisions with obstacles can cause a tine arm 5 of the rotary rake 1 to bend or even break off. This can also cause damage to a drive train (not shown) of the turning or raking rotor 3. In order to detect this at an early stage and to avoid consequential damages, the rotary rake 1 has a control device 90 which interacts with a sensor 7 (see FIG. 2) in order to draw conclusions from a measurement signal 71 (see FIG. 3) from the sensor 7 about an operating state of fault operation 92, 93 (see FIGS. 3 (b) and (c)).

The tractor can interact with a tractor control unit 80 to indicate such a malfunction 92, 93 to an operator. Alternatively or additionally, the control device 90 or the tractor control unit 80 can be set up to initiate an auxiliary measure to prevent a consequential damage. Alternatively or additionally, the control device 90 or the tractor control unit 80 can be set up to transfer the rotary rake 1 to a fault position, for example, to a headland or transport position (not shown).

The function of the control device 90 is described in FIG. 2.

FIG. 2 shows a section of a further embodiment of a haymaking machine 1, in this case a rotary tedder 1. In the context of FIG. 2, the terms haymaking machine 1 and rotary tedder 1 are therefore used synonymously.

The rotary rake 1/rotary tedder 1 has a large number of turning or raking rotors 3, which are arranged next to each other at right angles to the direction of travel F of the work train. For this purpose, it also has a frame 2 which is designed as a machine beam 1 and extends transversely to the direction of travel F. The turning or raking rotors 3 are arranged at approximately the same distance from each other along the machine beam 2.

In relation to its turning and raking rotors 3, the rotary tedder 1 is constructed symmetrically to a central plane 15. FIG. 2 (a) shows only one right arm (not labeled) of the rotary tedder 1 in its entirety. Only a first turning or raking rotor 3 of a left arm (not designated) of the rotary tedder 1 is shown. The rotary tedder 1 can be moved via actuators 12 from a working position, as shown in FIG. 2, into a headland or transport position, in which the arms of the rotary tedder 1 are raised relative to the working position.

It can be seen that the turning or raking rotors 3 are each supported by a feeler wheel 11 on the ground 6.

A three-point linkage 82 of a tractor 8 is also shown in the center of the rotary tedder 1, which carries the rotary turner 1. A PTO connection 13 for connecting the rotary tedder 1 to a power take-off (PTO, not shown) of the tractor 8 is also visible. The turning and raking rotors 3 of the rotary tedder 1 can therefore be driven via a PTO shaft (not shown) that can be connected to the tractor 8.

The turning or raking rotors 3 of the rotary tedder 1 are designed to pick up and turn crops from the ground 6 or a sward. The turning or raking rotors 3 therefore here have the function of turning rotors.

For this purpose, the turning or raking rotors 3 of the rotary turner 1 can also be rotated in the working position relative to the frame 2 about a rotation axis 4 in or in an opposite direction 41. On level ground, the rotation axis 4 is regularly aligned at a (small) acute angle of, for example, less than 10° to the vertical. To pick up the crop, the turning or raking rotors 3 of the rotary tedder 1 also have a large number of tine arms 5, on each of which tines 51 are arranged (see FIG. 2).

The tines 51 of the rotary tedder 1 are aligned towards the ground 6. They are, however, set at an angle (not shown) to the rotor's rotation axis 4 in order to optimally pick up and release the crop.

The tine arms 5 are evenly distributed in a circumferential direction around the rotation axis 4 and are aligned in an approximately radial direction 42 to the rotation axis 4. They do not, however, extend in a straight line but are curved.

A drive train (not shown) of the rotary tedder 1 has a rotary gear (not shown) for each of the turning or raking rotors 3, which converts a PTO shaft speed of the PTO shaft into a rotary speed of the turning or raking rotor 3 in a conversion ratio. The rotational speed of the rotary tedder 1 is usually slowed down compared to the PTO speed. FIG. 2 (b) shows a housing 31 of the rotor gearbox.

The rotary tedder 1 has a sensor 7 for each turning or raking rotor 3. In the illustrated example, a sensor 7 is shown as an example on the outer turning or raking rotor 3. The function of the sensor 7 is described below using this sensor 7 and the associated turning or raking rotor 3 as an example.

The sensor 7 is attached to the frame 2 so that it is stationary in relation to the tine arms 5 of the turning or raking rotor 3 during operation of the rotor tedder 1, i.e., when the turning or raking rotor 3 rotates about its rotor rotation axis 4. It is set up to continuously detect each of its tine arms 5 passing the sensor 7 during operation of the turning or raking rotor 3. The sensor 7 therefore detects a measurement signal 71 (see FIG. 3) in which each tine arm 5 generates a signal deflection 70 as it passes the sensor 7. The sensor 7 continuously detects the passing of the tine arms 5 during operation of the rotary tedder 1 so that a continuous measurement signal 71 is generated in which the signal deflections 70 are equally spaced apart in a normal operating state 91 (see FIG. 3 (a)) as long as the rotary speed of the turning or raking rotor 3 does not change.

The sensor 7 is designed as an inductive sensor 7. When a metallic component, in this case a tine arm, approaches, a magnetic flux changes, which leads to the signal deflection 70 of the measurement signal 71.

The rotary turner 1 also has a control device 90 which interacts with the sensor 7 in order to draw conclusions about the operating state of the turning or raking rotor 3 on the basis of the measurement signal 71.

FIG. 3 shows in (a) to (c) measurement signals 71 of a sensor 7 of the haymaking machines 1 of FIGS. 1 and 2.

FIG. 3 (a) shows the measurement signal 71 of the sensor 7 in a coordinate system in normal operating state 91. A rotation angle 72 is plotted on the X-axis and an amount 73 of the measurement signal 71 is plotted on the Y-axis.

Each tine arm 5 is detected as a signal deflection 70 by the sensor 7 assigned to the turning or raking rotor 3. If the rotor speed remains constant, the actual distance between the signal deflections 70 is approximately constant. The actual rotor speed of the turning or raking rotor 3 also corresponds to the calculated target rotor speed.

FIG. 3 (b) shows the measurement signal 71 of the sensor 7 in the fault operating state 92, in this case with the tine arm 5 bent. The tine arm 5 has entered a detection range of the sensor 7 later due to the bending and is therefore detected at a later angle of rotation 74.

FIG. 3 (c) shows the measurement signal 71 of sensor 7 also in the fault operating state 93, but here with the tine arm 5 missing. The tine arm 5 can no longer enter the detection range of sensor 7. An actual distance 75 between adjacent signal deflections 70 is approximately twice as large here as in a normal operating state 91.

By comparing the target rotor speed with the actual rotor speed, a slip or a defect in the drive train of the turning or raking rotor 3 can be detected if the deviation is more than 10% and/or lasts for more than one complete rotor rotation.

A defect in the drive train can, for example, also mean that the turning or raking rotor 3 no longer turns at all although a PTO shaft speed is applied to the PTO shaft. This can be detected as a faulty operation (not shown) with the sensor 7 as the measurement signal 71 then has no signal deflections 70.

Slippage in the drive train can also result in a change in speed, for example, after the power take-off of the tractor 8 is switched on, leading to a delay in reaching the target rotor speed.

An overrun of the reversing or raking rotor 3, for example, with the freewheel installed, can be detected by the reversing or raking rotor 3 still rotating after the auxiliary drive has been switched off. This can be detected by the sensor 7 as an interference mode (not shown), as the measurement signal 71 then still has signal deflections 70 despite the auxiliary drive being switched off.

The present invention is not limited to embodiments described herein; reference should be had to the appended claims.

### LIST OF REFERENCE CHARACTERS

1 Haymaking machine/Rotary rake/Rotary tedder
2 Frame/Machine beam
3 Raking rotor
4 Rotation axis
5 Tine arm
6 Ground
7 Sensor
8 Tractor
11 Feeler wheel
12 Actuator
13 PTO connection
15 Central plane
31 Housing
41 Opposite direction
42 Radial direction
51 Tines
70 Signal deflection
71 Measurement signal
72 Rotation angle
73 Amount
74 Angle of rotation
75 Actual distance between adjacent signal deflections 70
80 Tractor control unit
81 Drawbar
82 Three-point linkage
90 Control device
91 Normal operating state
92 Fault operating state (tine arm bent)
93 Fault operating state (tine arm missing)
F Direction of travel

1-12. (canceled)

13. A haymaking machine comprising:
a frame;
at least one turning or raking rotor which is arranged on the frame, the at least one turning or raking rotor being configured so that, in a working position, it is drivable relative to the frame about an axis of rotation in a direction of rotation of the at least one turning or raking rotor, the at least one turning or raking rotor comprising:
at least two tine arms each of which comprise tines for turning or raking a crop, the at least two tine arms being aligned at least temporarily so as to face the ground,
wherein,
the at least two tine arms are arranged uniformly distributed in a circumferential direction around the axis of rotation of the at least one turning or raking rotor and are aligned in an approximately radial direction with respect to the axis of rotation of the at least one turning or raking rotor;
a sensor which is arranged on the frame, the sensor being configured to continuously detect a passing of the at least two tine arms during an operation of the at least one turning or raking rotor and to transmit a measurement signal thereof; and
a control device which is configured to receive the measurement signal transmitted by the sensor and, based thereon, to infer an operating state of the at least one turning or raking rotor.

14. The haymaking machine as recited in claim 13, wherein the haymaking machine is a rotary tedder or a rotary rake.

15. The haymaking machine as recited in claim 13, further comprising:
a gyro gear for converting a current power take-off shaft speed into a gyro speed,
wherein,
the control device is further configured to calculate a target gyro speed of the at least one turning or raking rotor, taking into account at least one of a power take-off shaft speed for driving the gyro gear and a conversion ratio of the gyro gear.

16. The haymaking machine as recited in claim 13, wherein the measuring signal for the passage of each tine arm of the at least two tine arms past the sensor provides a signal deflection.

17. The haymaking machine as recited in claim 16, wherein the control device is further configured to continuously determine a current actual rotor speed on the basis of a number of the at least two tine arms and a frequency of the signal deflections of the measurement signal per full rotation of the at least one turning or raking rotor.

18. The haymaking machine as recited in claim 16, wherein the control device is further configured to compare a target rotational speed with an actual rotational speed and to detect the operating state as a fault operation if a deviation between the target rotational speed and the actual rotational speed exceeds 10%.

19. The haymaking machine as recited in claim 16, wherein the control device is further configured determine a desired spacing of the signal deflections, to compare the desired spacing with a current actual spacing of adjacent signal deflections of the measurement signal, and to detect the operating state as a fault operation if at least one of,
an actual distance deviates from a target distance by a value which corresponds to an angular error of more than 8° of a rotation of the at least one turning or raking motor, and
if the actual distance deviates from the target distance over more than one full rotation of the at least one turning or raking rotor.

20. The haymaking machine as recited in claim 19, wherein the control device is further configured to detect at least one of an impact on an obstacle, a bent tine arm, a missing tine arm, a slip in a drive train of the at least one turning or raking rotor, and a defect in a drive train as a fault operation on the basis of a comparison of a set distance and the actual distance.

21. The haymaking machine as recited in claim 13, wherein the sensor is a reed sensor, an inductive sensor, a capacitive sensor, an ultrasonic sensor, a light sensor, or a light barrier sensor.

22. The haymaking machine as recited in claim 13, wherein,
a plurality of the at least one turning or raking rotor is provided, and
a sensor is assigned to each of the plurality of turning or raking rotors.

23. A work train comprising:
a tractor; and
a haymaking machine as recited in claim 20,
wherein,
the haymaking machine is attached to the tractor or mounted on the tractor (8).

24. The work train as recited in claim 23, wherein,
the tractor comprises a tractor control, and
the control device of the haymaking machine is further configured transmit the fault operation to the tractor control.

25. The work train as recited in claim 23, wherein the tractor control is configured to at least one of indicate the fault operation to the operator, to initiate an auxiliary measure to prevent a consequential damage, and to transfer the haymaking machine to a fault position.
